(19) United States
(12) Patent Application Publication
(10) Pub. No.: US 2004/0260975 A1
(43) Pub. Date: Dec. 23, 2004

(54) Semiconductor integrated circuit

(75) Inventor: Yoshihiro Nagura, Tokyo (JP)

Correspondence Address: BURNS, DOANE, SWECKER & MATHIS, L.L.P., P.O. Box 1404, Alexandria, VA, 22313-1404, US

(73) Assignee: MITSUBISHI DENKI KABUSHIKI KAISHA

(21) Appl. No.: 10/430,276

(22) Filed: May 7, 2003

(30) Foreign Application Priority Data
Nov. 7, 2002 (JP) 2002-324379

(51) Int. Cl. H02H 3/05

(52) U.S. Cl. 714/30

(57) ABSTRACT

A command generator outputs a test generation signal when an instruction in a program stored in an instruction memory is a test clock generating command. A timing test clock generator generates a test clock based on a timing margin clock having a different phase from that of the master clock and a test clock generation signal. A timing test control circuit generates a signal for controlling the timing of the memory, based on the master clock and the test clock and performs a test of the memory.

### BACKGROUND OF THE INVENTION

1) Field of the Invention

The present invention relates to a semiconductor integrated circuit in which an on-board memory is testing for a timing margin of the on-board memory by using a built-in self-test (BIST) circuit.

2) Description of the Related Art

Recently, the on-board gate size of one chip of the semiconductor integrated circuit has increased with an improvement in the multilayer interconnection and the microfabrication in manufacturing semiconductors. Therefore, testing of the semiconductor integrated circuit after its production has become difficult.

One of the problems when performing the test is that there a limitation in the ability of an LSI tester (Automated Test Equipment: ATE). This problem may be overcome by methods such as performing scanning design at the time of designing a semiconductor integrated circuit, or by loading a BIST circuit. These methods are particularly effective in a random logic circuit.

In the case of an embedded memory device having a memory built-in a semiconductor integrated circuit, however, it is necessary to test for a timing margin of the memory built-in the semiconductor integrated circuit. The timing margin test for the memory is performed by using a timing margin clock in addition to a master clock for the test and utilizing a phase difference in these two clocks. Since it is difficult to generate these two clocks by the BIST circuit, an ATE program is used to generate the timing margin clock that occurs with a phase difference suitable for the timing margin test and only at a necessary test cycle, with respect to the master clock for the test, and apply it to the semiconductor integrated circuit. Therefore, a test program for the BIST circuit and a program for generating the timing margin clock in the ATE are required, causing a problem in that the generation of the test program becomes complicated.

Moreover, debugging must be performed together with the test program for the BIST circuit, relating to the validity, whether the timing margin clock occurs with a phase difference suitable for the timing margin test and only at a necessary test cycle, with respect to the master clock for the test, thereby causing a problem in that the debugging efficiency of the test program decreases.

In order to overcome these problems, in the prior art (for example, see Japanese Patent Application Laid-Open No. 8-315598), a phase locked loop (PLL) circuit is loaded in the semiconductor integrated circuit to multiply the master clock for the test, and a multiphase clock is generated from the multiplied clock, using a demultiply circuit, to thereby generate a timing margin clock.

According to the prior art, the test program for the ATE and the BIST circuit can be simplified, but the PLL circuit and the demultiply circuit must be loaded in the semiconductor integrated circuit, causing a problem in that the circuit size of the semiconductor integrated circuit increases. Moreover, there is a problem with the prior art that since it is necessary to test for the operation of the PLL circuit and the demultiplier, the self-test by the BIST circuit becomes complicated.

### SUMMARY OF THE INVENTION

The present invention has been achieved in order to solve the above problems. It is an object of the present invention to obtain a semiconductor integrated circuit that can perform a timing margin test for an on-board memory by using a simple program, without using a complicated circuit for generating a timing margin clock in a semiconductor integrated circuit.

The semiconductor integrated circuit according to the present invention operates with a master clock input from outside, and it has a computer program for testing a memory built-in the semiconductor integrated circuit. The semiconductor integrated circuit comprises a command generator that outputs a test clock generation signal when an instruction in the program is a test clock generating command; a timing test clock generator that generates a test clock based on a timing margin clock having a different phase from that of the master clock and the test clock generation signal; and a timing test control circuit that controls the timing of the memory, based on the master clock and the test clock.

Thus, the instruction for generating the timing test clock is prepared in instructions in the program for testing the built-in memory, and the timing for generating a clock necessary for the timing margin test is determined by the instruction. Only at the determined timing, a timing margin clock having a predetermined phase difference with respect to the master clock and having the same cycle and the same waveform is designated as a test clock, and the timing of the memory is controlled based on this test clock and the master clock, to thereby perform the timing margin test.

These and other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 shows a configuration of a semiconductor integrated circuit in a first embodiment of this invention;

FIG. 2 is a timing chart that explains the operation of a timing test clock generator in the semiconductor integrated circuit in the first embodiment;

FIG. 3 shows a configuration of a semiconductor integrated circuit in a second embodiment of this invention;

FIG. 4 is a timing chart that explains the operation of the timing test clock generator in the semiconductor integrated circuit in the second embodiment; and

FIG. 5 shows a configuration of a semiconductor integrated circuit in the second embodiment.

### DETAILED DESCRIPTION

Exemplary embodiments of the semiconductor integrated circuit according to the present invention are explained in detail below with reference to the accompanying drawings.

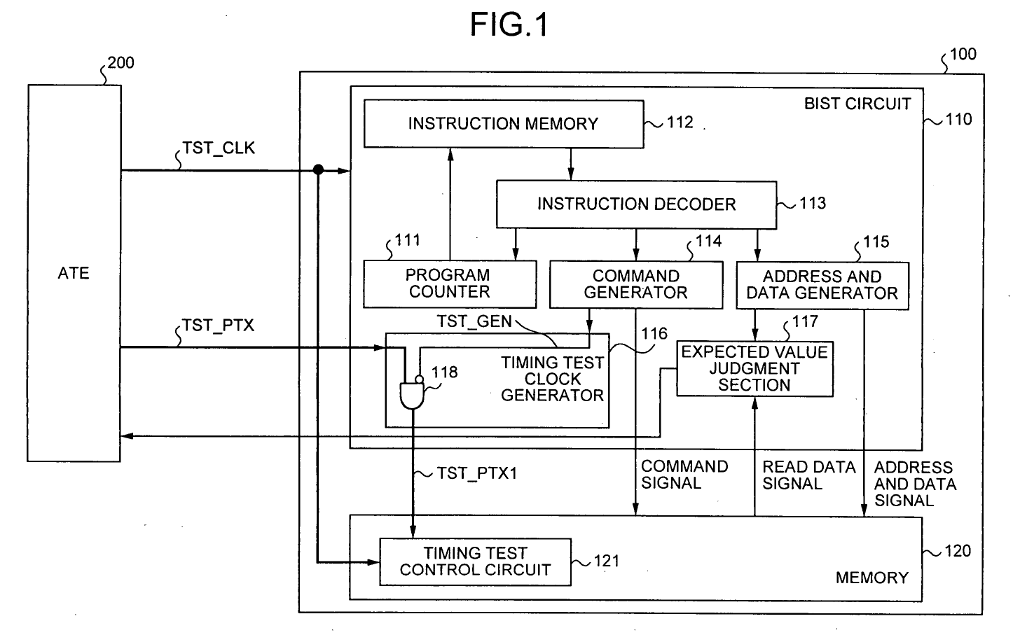

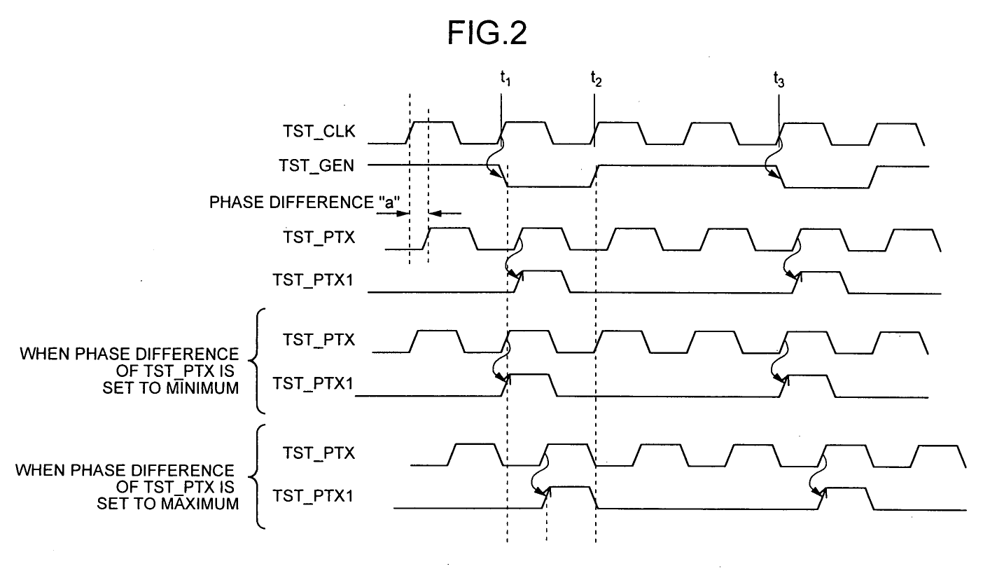

A first embodiment of the present invention is explained with reference to FIG. 1 and FIG. 2. FIG. 1 is a block diagram that shows the configuration of a semiconductor integrated circuit 100 in a first embodiment in the present invention. The semiconductor integrated circuit 100 comprises a BIST circuit 110, a memory 120 that is to be tested, and a macro cell (not shown) such as a random logic circuit or a CPU core. When performing the test, the semiconductor integrated circuit 100 operates by a master clock TST_CLK generated by the ATE 200, being an LSI tester.

The BIST circuit 110 has a function of testing the memory 120, comparing an expected value with the test result, and outputting the comparison result. The BIST circuit 110 comprises an instruction memory 112, a program counter 111, an instruction decoder 113, a command generator 114, an address and data generator 115, a timing test clock generator 116 and an expected value judgment section 117.

The program counter 111 counts the master clock TST_CLK, generates an address of the instruction memory 112, and outputs the address to the instruction memory 112.

The instruction memory 112 comprises, for example, a read only memory (ROM) and a random access memory (RAM), stores an instruction, being a program for performing the test for the memory 120, and outputs the instruction stored at an address specified by the program counter 111 to the instruction decoder 113.

The instruction decoder 113 decodes the instruction, and outputs a control signal corresponding to the instruction to the program counter 111, the command generator 114, and the address and data generator 115. Specifically, for example, when the instruction is a jump command, the instruction decoder 113 outputs a control signal for changing the value of the program counter 111 to the address to be jumped, to the program counter 111. When the instruction is a timing margin clock generation command, the instruction decoder 113 outputs a clock generation control signal for generating a test clock generation signal TST_GEN to the command generator 114. When the instruction is an addressing command, the instruction decoder 113 outputs an address and data control signal for generating any one of an address and data or both to the address and data generator 115.

The command generator 114 generates the test clock generation signal TST_GEN based on the clock generation control signal, and outputs the generated test clock generation signal TST_GEN to the timing test clock generator 116. The command generator 114 outputs a command signal to the memory 120.

The address and data generator 115 outputs the address and write data to the memory 120 based on the address and data control signal, and outputs the write data to the expected value judgment section 117.

The timing test clock generator 116 outputs a test clock TST_PTX1, based on the timing margin clock TST_PTX generated by the ATE 200 and input from an external terminal of the semiconductor integrated circuit 100, and the test clock generation signal TST_GEN input from the command generator 114. Specifically, the timing test clock generator 116 comprises an AND 118, being an AND gate.

The expected value judgment section 117 designates data input from the address and data generator 115 as the expected value, and compares the data read from the memory 120 with the expected value, and outputs the result to the ATE 200.

The memory 120 comprises a RAM or a ROM, and a timing test control circuit 121 that generates a chip select signal, a write enable signal, a read enable signal and the like, based on the master clock TST_CLK generated by the ATE 200 and input from the external terminal of the semiconductor integrated circuit, and the test clock TST_PTX1 generated by the timing test clock generator 116.

The operation of the semiconductor integrated circuit 100 in the first embodiment is explained below. The BIST circuit 110 and the memory 120 operate synchronously with the master clock TST_CLK generated by the ATE 200.

The program counter 111 counts the master clock TST_CLK from a predetermined value sequentially, and outputs the count value to the instruction memory 112. The instruction memory 112 reads the instruction stored at the address specified by the program counter 111, and outputs the read instruction to the instruction decoder 113.

The instruction decoder 113 decodes the instruction and outputs a control signal corresponding to the instruction. Here, it is assumed that the instruction is a timing margin clock generation command. The instruction decoder 113 outputs a clock generation control signal for generating the test clock generation signal TST_GEN to the command generator 114.

The command generator 114 generates the test clock generation signal TST_GEN based on the clock generation control signal, and outputs the generated test clock generation signal TST_GEN to the timing test clock generator 116.

The timing test clock generator 116 outputs the test clock TST_PTX1 based on the timing margin clock TST_PTX generated by the ATE 200 and input from the external terminal of the semiconductor integrated circuit 100, and the test clock generation signal TST_GEN input from the command generator 114.

The operation of the timing test clock generator 116 is explained in detail, with reference to the timing chart in FIG. 2. Since the BIST circuit operates synchronously with the master clock TST_CLK generated by the ATE 200, the test clock generation signal TST_GEN input from the command generator 114 synchronizes with the master clock TST_CLK to become a time asserted condition for one cycle of the master clock TST_CLK. In the case of FIG. 2, the test clock generation signal TST_GEN synchronizes with the rise of the master clock TST_CLK, to become “L” for one cycle of the master clock TST_CLK.

The timing margin clock TST_PTX generated by the ATE 200 and input from the external terminal of the semiconductor integrated circuit 100 is a clock having the same cycle and the same waveform as those of the master clock TST_CLK, and has a phase difference “a” with respect to the master clock TST_CLK. The phase difference “a” is designated as from 0 to half the cycle of the master clock TST_CLK, based on the rise of the master clock TST_CLK. In other words, the timing margin clock TST_PTX can be easily generated by controlling the delay timing, based on the master clock TST_CLK in the program for the ATE 200.

The timing test clock generator 116 comprises an AND 118. Signals obtained by inverting the polarity of the timing margin clock TST_PTX and the test clock generation signal TST_GEN are input to the AND 118. The AND 118 allows the timing margin clock TST_PTX to go through only for the period of from t₁ to t₂, during which the test clock generation signal TST_GEN is “L”, and outputs the test clock TST_PTX1. In the period of from t₂ to t₃, during which the test clock generation signal TST_GEN is “H”, the AND 118 makes the output “L”, regardless of the change of the timing margin clock TST_PTX. In other words, the AND 118 changes test clock TST_PTX1 to “L”, while the test clock generation signal TST_GEN is “H”.

In the ATE 200, when the phase difference of the timing margin clock TST_PTX is set to the minimum, that is, when the rise of the timing margin clock TST_PTX and the rise of the master clock TST_CLK are made the same, the test clock TST_PTX1 becomes a clock that rises synchronously with the rise of the master clock TST_CLK.

In the ATE 200, when the phase difference of the timing margin clock TST_PTX is set to the maximum, that is, when the fall of the timing margin clock TST_PTX and the rise of the master clock TST_CLK are made the same, the test clock TST_PTX1 becomes a clock that rises synchronously with the fall of the master clock TST_CLK.

The timing test clock generator 116 generates the test clock TST_PTX1 in this manner, in a cycle necessary for the timing margin test. In the case of FIG. 2, the timing test clock generator 116 outputs the test clock TST_PTX1 for every three cycles of the master clock TST_CLK.

The timing test control circuit 121 generates the chip select signal, the write enable signal, the read enable signal and the like, based on the master clock TST_CLK and the test clock TST_PTX1, to operate the memory 120.

For example, it is assumed that the data at the address specified by the address and data generator 115 is read by the timing test control circuit 121. In this case, the expected value judgment section 117 compares the data at the address specified by the address and data generator 115 with the expected value, and outputs the result to the ATE 200.

In this manner, in the first embodiment, the instruction for generating the timing test clock is prepared in instructions in the program for the BIST circuit, and the timing for generating a clock necessary for the timing margin test is determined by the instruction. Only at the determined timing, a timing margin clock having a predetermined phase difference with respect to the master clock generated by the ATE and having the same cycle and the same waveform is output as a test clock. As a result, the timing control of the test clock, that is, the timing control of the timing margin clock with respect to the master clock can be easily controlled in the program for the ATE.

Since the timing control for generating the timing margin clock is determined by the instruction, debugging of the program is easy.

Further, since it is not necessary to have a special circuit in the BIST circuit, the circuit size of the semiconductor integrated circuit can be suppressed, thereby simplifying the self-diagnostic test by the BIST circuit.

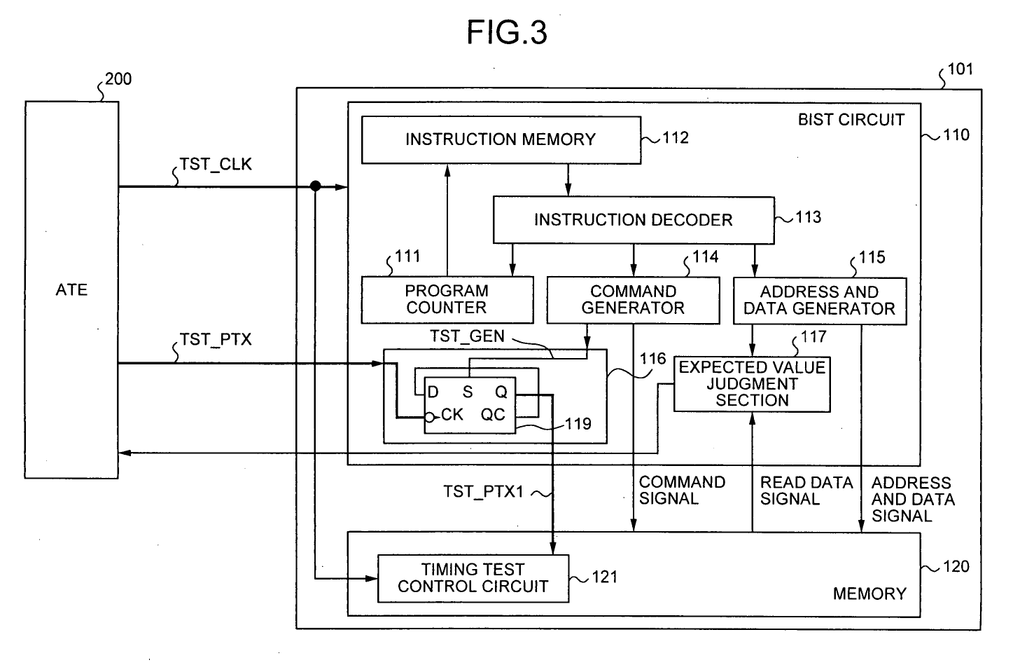

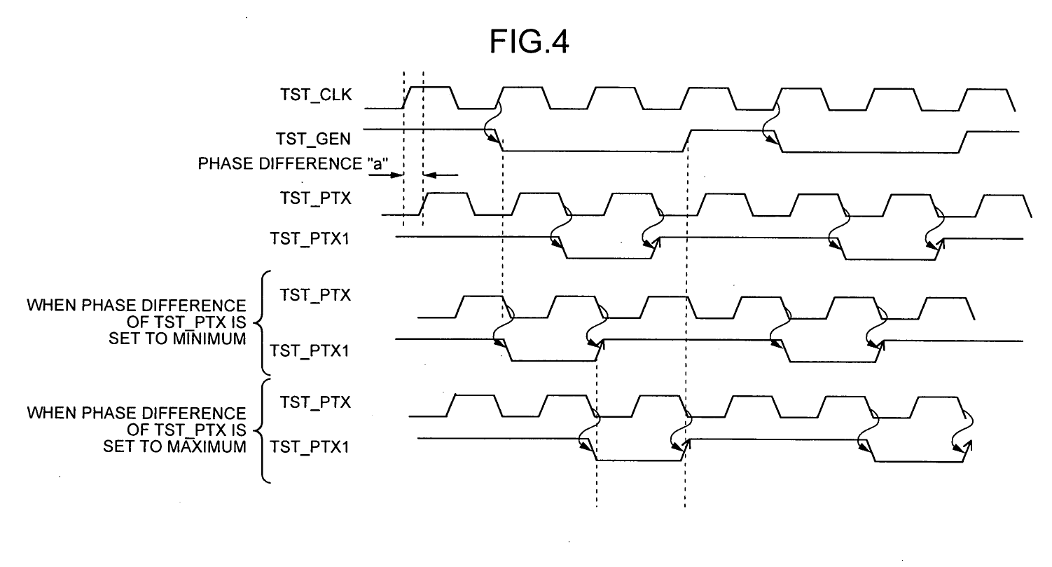

A second embodiment of the present invention is explained with reference to FIG. 3 and FIG. 4. FIG. 3 is a block diagram that shows the configuration of the semiconductor integrated circuit 101 in the second embodiment in the present invention. The components having the same function as in the first embodiment are denoted by the same reference sign, and explanation thereof is omitted to avoid simple repetition of explanation.

The timing test clock generator 116 in the second embodiment comprises an FF 119, being a set negative edge flip-flop. The test clock generation signal TST_GEN generated by the command generator 114 is input to a set terminal S of the FF 119. The timing margin clock TST_PTX generated by the ATE is input to a clock terminal CK of the FF 119. An output terminal QC of the FF 119 is input to a data terminal D of the FF 119. The output terminal Q of the FF 119 is the test clock TST_PTX1, being the output of the timing test clock generator 116, and outputs the test clock TST_PTX1 to the timing test control circuit 121.

The operation of the semiconductor integrated circuit 101 in the second embodiment is explained below. The detailed explanation for the similar operation to that of the first embodiment is omitted.

The instruction memory 112 outputs the instruction at the address specified by the program counter 111 to the instruction decoder 113. When the instruction is a timing margin clock generation command, the instruction decoder 113 outputs a clock generation control signal for generating the test clock generation signal TST_GEN to the command generator 114. The command generator 114 generates the test clock generation signal TST_GEN based on the clock generation signal, and outputs the generated test clock generation signal TST_GEN to the timing test clock generator 116. The timing test clock generator 116 outputs a test clock TST_PTX1 based on the timing margin clock TST_PTX and the test clock generation signal TST_GEN.

The operation of the timing test clock generator 116 is explained in detail, with reference to the timing chart in FIG. 4. The test clock generation signal TST_GEN input from the command generator 114 synchronizes with the master clock TST_CLK to become a time asserted condition for one cycle of the master clock TST_CLK. In the case of FIG. 4, the test clock generation signal TST_GEN synchronizes with the rise of the master clock TST_CLK, to become “L” for two cycles of the master clock TST_CLK.

The timing margin clock TST_PTX generated by the ATE 200 and input from the external terminal of the semiconductor integrated circuit 101 is a clock having the same cycle and the same waveform as those of the master clock TST_CLK, and has a phase difference “a” with respect to the master clock TST_CLK. The phase difference “a” can be changed for the half cycle of the master clock TST_CLK before and after, based on the rise of the master clock TST_CLK. In other words, the timing margin clock TST_PTX1 rises during one cycle from the fall of the master clock TST_CLK.

The timing test clock generator 116 comprises the FF 119. The test clock generation signal TST_GEN is input to the set terminal S of the FF 119. Therefore, while the test clock generation signal TST_GEN is “H”, the FF 119 changes the output terminal Q to “H”, and the output terminal QC to “L”, by the set function. As a result, the test clock TST_PTX1 is fixed to “H”.

When the test clock generation signal TST_GEN becomes “L”, the FF 119 latches the data at the input terminal D, with the fall of the timing test clock TST_PTX. In other words, the FF 119 changes the output terminal Q to “L”, and the output terminal QC to “H”. As a result, the test clock TST_PTX1 is fixed to “L”. At the next fall of the timing test clock TST_PTX, the FF 119 changes the output terminal Q to “H”, and the output terminal QC to “L”. As a result, the test clock TST_PTX1 is fixed to “H”. Further, at the next fall of the timing test clock TST_PTX, the FF 119 changes the output terminal Q to “H”, and the output terminal QC to “L” by the set function, since the test clock generation signal TST_GEN becomes “H”. As a result, the test clock TST_PTX1 is fixed to “H”.

When the phase difference of the timing margin clock TST_PTX is set to the minimum in the ATE 200, the test clock TST_PTX1 becomes “L” during one cycle of the master clock TST_CLK, immediately after the test clock generation signal TST_GEN becomes When the phase difference of the timing margin clock TST_PTX is set to the maximum in the ATE 200, the test clock TST_PTX1 becomes “L” during one cycle of the master clock TST_CLK, immediately before the test clock generation signal TST_GEN becomes H.

In this manner, the timing test clock generator 116 outputs the test clock TST_PTX1 for one cycle of the master clock TST_CLK, during two cycles of the master clock TST_CLK, where the test clock generation signal TST_GEN is negated.

The timing test control circuit 121 generates the chip select signal, the write enable signal, the read enable signal and the like, based on the master clock TST_CLK and the test clock TST_PTX1, to operate the memory 120.

For example, it is assumed that the data at the address specified by the address and data generator 115 is read by the timing test control circuit 121. In this case, the expected value judgment section 117 compares the data at the address specified by the address and data generator 115 with the expected value, and outputs the result to the ATE 200.

In this manner, in the second embodiment, the instruction for generating the timing test clock is prepared in instructions in the program for the BIST circuit, and the timing for generating a clock necessary for the timing margin test is determined by the instruction. Only at the determined timing, a timing margin clock having a predetermined phase difference with respect to the master clock generated by the ATE and having the same cycle and the same waveform is output as a test clock. As a result, the timing control of the test clock, that is, the timing control of the timing margin clock with respect to the master clock, can be easily controlled in the program for the ATE.

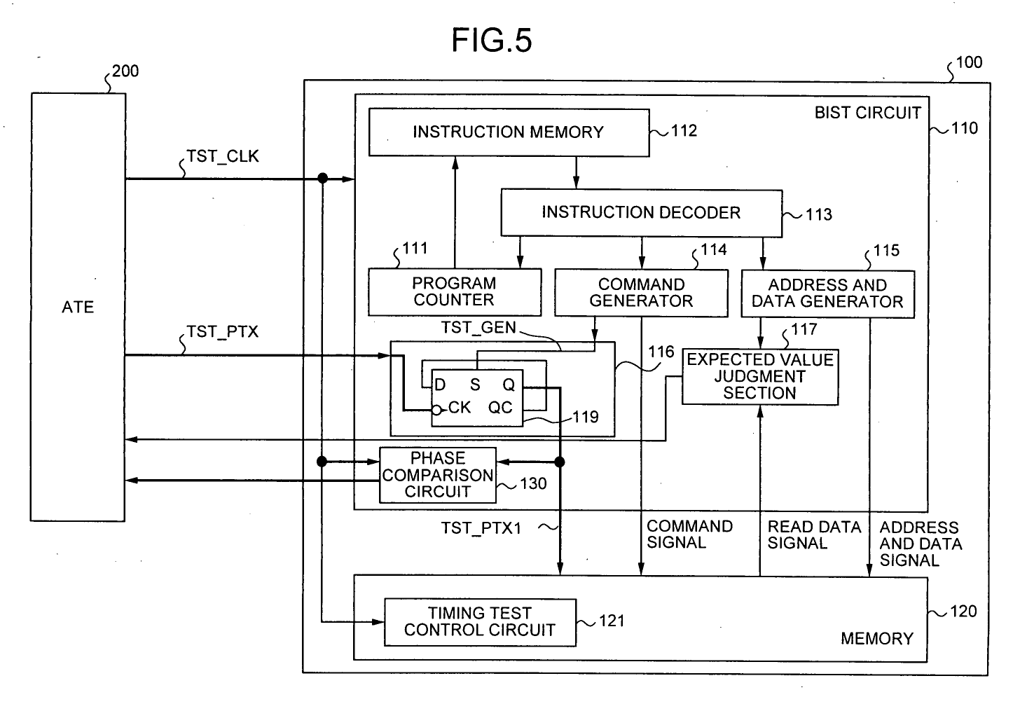

As shown in FIG. 5, the BIST circuit 110 may comprise a phase comparison circuit 130, to thereby compare the phases of the master clock TST_CLK with the test clock TST_PTX1. The phase comparison circuit 130 then outputs a phase comparison result signal indicating a phase shift of the test clock TST_PTX1 generated by the timing test clock generator 116 with respect to the master clock, to the ATE 200, as a result of comparison. As a result, an offset in the phase difference between the master clock TST_CLK and the test clock TST_PTX1 can be detected, by making the timing for generating the timing margin clock TST_PTX variable in the ATE 200.

According to this invention, in the semiconductor integrated circuit, an instruction for generating the timing test clock is prepared in instructions in the program for testing the built-in memory, and the timing for generating a clock necessary for the timing margin test is determined by the instruction. Only at the determined timing, a timing margin clock having a predetermined phase difference with respect to the master clock and having the same cycle and the same waveform is designated as a test clock, and the timing of the memory is controlled based on this test clock and the master clock, to thereby perform the timing margin test. As a result, a clock necessary for the timing margin test of the memory can be generated, without using a special circuit or special test program for each necessary cycle.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A semiconductor integrated circuit, which operates with a master clock input from outside, having a computer program for testing a memory built-in the semiconductor integrated circuit, the semiconductor integrated circuit comprising:
a command generator that outputs a test clock generation signal when an instruction in the program is a test clock generating command;
a timing test clock generator that generates a test clock based on a timing margin clock having a different phase from that of the master clock and the test clock generation signal; and
a timing test control circuit that controls the timing of the memory, based on the master clock and the test clock.

2. The semiconductor integrated circuit according to claim 1, wherein the command generator outputs the test clock generation signal for n, where n is a natural number, cycles of the master clock, and
the timing test clock generator outputs the timing margin clock as the test clock, only when the command generator outputs the test clock generation signal.

3. The semiconductor integrated circuit according to claim 1, wherein the command generator outputs the test clock generation signal for n, where n is a natural number, cycles of the master clock, and
the timing test clock generator outputs the test clock for m, where m is a natural number, cycles of the timing margin clock, during a period in which the command generator outputs the test clock generation signal.

4. The semiconductor integrated circuit according to claim 1, further comprising a phase comparison circuit that compares the phase of the master clock and the phase of the test clock, to detect a phase difference between the master clock and the test clock.

5. The semiconductor integrated circuit according to claim 1, further comprising an instruction memory for storing the computer program.

6. The semiconductor integrated circuit according to claim 1, wherein the instruction memory is any one of or a combination of a read only memory and a random access memory.
